(19) United States
(12) Patent Application Publication
(10) Pub. No.: US 2023/0083898 A1
(43) Pub. Date: Mar. 16, 2023

(54) SYSTEMS AND METHODS FOR LIST TRADING OF ASSET-BACKED SECURITIES

(71) Applicant: Tradeweb Markets LLC, New York, NY (US)

(72) Inventors: Justin Monahan, Rockville Centre, NY (US); Hadley Manfredi, New York, NY (US); Randy Goldsmith, New York, NY (US); Chika Jasper Nwafor, New York, NY (US)

(21) Appl. No.: 17/985,329

(22) Filed: Nov. 11, 2022

Related U.S. Application Data
(62) Division of application No. 17/395,772, filed on Aug. 6, 2021.
(60) Provisional application No. 63/062,196, filed on Aug. 6, 2020.

(51) Int. Cl. G06Q 40/04; G06F 16/9538; G06Q 30/02

(52) U.S. Cl. CPC G06Q 40/04; G06F 16/9538; G06Q 30/0206

(57) ABSTRACT

Disclosed herein are systems and methods that provide improved list trading functionality for the mortgage origination sector. The system includes dealer software that provides at least one of a carry calculator configured to calculate a carry valuation of a bond based on predetermined data; a weighted average matrix functionality configured to calculate a single weighted average bid/offer for a group of bonds; a price matrix that allows users to quote in spread and compute an all-in dollar price bid; an axe indicator for dealers to indicate in real time if a quote is axed; and shared views allowing multiple users across trading and sales to view the inputs of other users in real time.

### CROSS-REFERENCE TO RELATED APPLICATION

This application claims the benefit of Provisional Application Ser. No. 63/062,196, filed Aug. 6, 2020, entitled “Systems and Methods for List Trading of Asset-Backed Securities,” the entire disclosure of which is hereby incorporated by reference.

### BACKGROUND

Asset-backed securities are bonds that are backed by, or in other words “invested” in, a pool of assets, such as mortgages. Asset-backed securities use a pool of assets to diversify the security's holdings and reduce risk that the failure of any one asset in the pool will have a disproportional effect on the value of the whole.

The trading of asset-backed securities, such as mortgage-backed securities (MBS), has typically been performed on a to-be-announced (TBA) basis in which the buyer (also known as the “liquidity taker”) and seller (also known as the “liquidity provider”) agree on the general terms of the trade for a pool of assets. However, the specific assets that will be included in the security are not selected and are only revealed by the seller days after the trade, but in advance of the settlement of the trade. Thus, while the buyer can achieve a general investment objective through TBA trading, the buyer is unable to truly customize the security.

In the alternative, specified pool trading permits the buyer to select specific asset-backed securities to be included in the pool such that the details of the pool of assets is known to the buyer at the time of the trade. Thus, unlike TBA trading, the seller provides information to buyers about various asset-backed securities and the buyer makes its selections from the group of asset-backed securities provided by the seller. Due to the transparency, specified pool trading is generally higher cost than TBA trading.

In the recent market environment, buyers of asset-backed securities may begin to focus on the need to pick and choose the specific asset pools, namely specified pools, that may outperform or meet more particularized goals than generic TBAs. The ability to more accurately forecast the behavior of individual pools by better understanding the specific characteristics of the loans (and their respective borrowers in the case of MBS) can provide buyers with an additional ability to develop trading strategies.

Systems and methods for specified pool trading and, in particular, for the creation, communication, price quotation, and execution of trades for specified pools of asset-backed securities, are described, for example, in U.S. Pat. No. 10,049,405, which is incorporated by reference herein in its entirety. Such systems and methods can overcome technical problems identified with specified pool trading, particularly in the mortgage-backed security markets, and in various embodiments can (i) provide an efficient and accessible platform for permitting liquidity providers (e.g., dealers; also known as market-makers) to offer various types of mortgage-backed securities, and for permitting liquidity takers (e.g., other dealers, investors and buy-side customers) to access a database of MBS, either specify criteria for stipulated pools or select one or more mortgage-backed securities to create a specified pool list, or select criteria for a to be created specified pool; (ii) provide mechanisms permitting market participants to submit the selected pool(s) to one or more counterparties, receive quotes from the counterparties, and conduct trades for the specified pools; (iii) provide customers of asset-backed securities, such as MBS, the ability to specify criteria for a pool that is not currently listed in a seller's inventory, and submit that criteria to the seller for creation of a stipulated pool; and/or (iv) permit the straight-through-processing of specified pool trades, as disclosed, for example, in U.S. Pat. No. 7,433,842, which is incorporated by reference herein in its entirety.

### SUMMARY

Various embodiments of the invention provide a computer system for executing transactions of pools of asset-based securities, each pool comprising a specified pool identified with a unique CUSIP number or a stipulated pool having characteristics defined by a user prior to securitization, wherein the system includes dealer software providing at least one of: a carry calculator configured to calculate a carry valuation of a bond based on predetermined data; a price matrix functionality configured to calculate a single weighted average bid/offer for a group of bonds; an axe indicator for dealers to indicate in real time if a quote is axed; and shared views allowing multiple users across trading and sales to view the inputs of other users in real time.

In some embodiments, the system further comprises customer software providing at least one of: grouping functionality allowing users to define group level trading protocols; net spotting and net hedging functionality configured to aggregate spot requests and hedges by benchmark, by dealer; and response validation functionality for customers to provide validated feedback to the dealers regarding competitive status of their quotes.

In some embodiments, the system further comprises pool description validation functionality configured to query a system database to validate an attribute associated with a user-defined pool description, and to provide an indication of such validation and/or block further action if the user-defined pool description is not validated.

One embodiment provides for a computer implemented method of executing transactions of pools of asset-backed securities utilizing a trading platform. The method comprises receiving through the trading platform a listing of pools of asset-backed securities from a first user; displaying through the trading platform the listing of pools of asset-backed securities simultaneously for one or more second users and one or more dealers; receiving through the trading platform from one or more of the second users multiple price quotes related to one or more of the pools of asset-backed securities; sending through the trading platform the multiple price quotes to a specified dealer from the one or more second users; aggregating through the trading platform the one or more price quotes; sending through the trading platform one or more of the multiple price quotes to the first user from the specified dealer; wherein if the first user approves a price quote of a second user received from the specified dealer, the specified dealer executes a first transaction based on said price quote through the trading platform with the first user and a second transaction based on said price quote through the trading platform with the second user.

Additional features and advantages of the present invention are described further below. This summary section is meant merely to illustrate certain features of embodiments of the invention, and is not meant to limit the scope of the invention in any way. The failure to discuss a specific feature or embodiment of the invention, or the inclusion of one or more features in this summary section, should not be construed to limit the invention as claimed.

### BRIEF DESCRIPTION OF THE DRAWINGS

The foregoing summary, as well as the following detailed description of certain embodiments, will be better understood when read in conjunction with the appended drawings, in which there are shown certain preferred embodiments. It should be understood, however, that the invention is not limited to the precise arrangements, structures, features, embodiments, aspects, systems, and instrumentalities shown and that the arrangements, structures, features, embodiments, aspects, systems, and instrumentalities shown may be used singularly or in combination with other arrangements, structures, features, embodiments, aspects, systems, and instrumentalities. The drawings are not in any way intended to limit the scope of this invention, but merely to clarify one or more embodiments of the invention. In the drawings:

FIG. 1 shows an exemplary list manager user interface, according to certain embodiments of the present invention;

FIG. 2 shows a screen with exemplary list manager filters, according to certain embodiments of the present invention;

FIG. 3 shows a flow diagram for solicited messaging according to one embodiment of the present invention; and

FIG. 4 shows a flow diagram for trading to a defined cover according to one embodiment of the present invention.

### DETAILED DESCRIPTION

Embodiments of the present invention provide improved systems and methods for list trading, relative to the list trading functionality that is currently utilized to execute agency pass-through specified pools. While the TBA market has slowly evolved over the past twenty years and is now executed approximately 75% electronically, the specified pool market is less than 5% digitized with only a handful of electronic offerings available at the institutional level. With approximately $27 BN average daily volume (ADV) trading in the market in 2020, the sector is ripe for technical development and has tremendous demand for an improved trading solution.

As used herein and as can be appreciated by one of the ordinary skill in the art the following terms have the following meanings as is known in the financial sector:

Average Loan Size (“ALS”)—The current remaining principal balance divided by the number of loans.

Coupon—Annual rate of interest paid to the investor. 12 times the monthly rate of interest. Used to calculate monthly interest payments.

CUSIP—9-character identifier for a traded security. The 9th digit is typically a check digit.

Factor—Decimal fraction of the original principal remaining. Calculated by dividing the total remaining principal balance of the loans by the original unpaid principal balance of the loans. Carried out to 8 decimal places for FNMA and GNMA, to 7 places for FHLMC.

FHLMC—Federal Home Loan Mortgage Corporation.

FNMA—Federal National Mortgage Association.

GNMA—Government National Mortgage Association.

Loan-to-Value (LTV)—Ratio of loan amount to value of property. It's the original value, weighted by the current loan balance. The LTV used for each pool is typically the latest LTV published by the agencies. This is a weighted average, calculated from each loan's original LTV. The weighting shifts as the loans pay down at different rates, but the underlying LTV for the loans themselves are not updated monthly.

Mat Date—The maturity date of a security. This date is typically the payment date following the maturity date of the longest loan in the pool.

Max Geo State—The US state with the highest percentage of loan balances. “95% TX” means that 95% of the loan balances are from Texas.

TPO %—Third Party Origination Percent. Indicates the % of issue amount that was third party origination.

Weighted-Average Coupon (WAC)—. Weighted average of the coupon rates of the underlying loans. If the collateral consists of pools, the weighted average of the underlying pool WACs. If WAC is not published for a pool, it is approximated by adding an assumed service fee to the published Coupon rate. The difference between the WAC and the Coupon is known as the service fee—the fee retained by the servicer.

WALA—Weighted-Average Loan Age. Weighted average number of months since origination of the underlying loans, or, if the collateral consists of pools, the weighted average of the underlying pool WALAs.

WLTV—Weighted Loan-to-Value For each pool it is the weighted average calculated from each loan's original LTV where the LTV is the ratio of loan amount to value of property or the original value, weighted by the current loan balance. The weighting shifts as the loans pay down at different rates.

WAM—Weighted-Average Maturity, measured in months. A weighted average of the number of months to maturity of the underlying loans, or, if the collateral consists of pools the weighted average of the underlying pool WAMs. Also known as weighted average remaining maturity (WARM) and weighted average remaining term (WART).

Whole Pool Face—Issue Amount, also known as the Original Face. For mortgage pools, it represents the total Unpaid Principal Balance of the loans on the date of issue.

In some embodiments, the systems and methods of the present invention may provide dealer (sell-side) software implementing a bond carry calculator that can significantly reduce the time it takes a trader to derive an accurate bid/offer for non-standard settle pools. The systems and methods may also provide a price matrix functionality that gives the user the ability to input bids on individual line items to arrive at a weighted average bid/offer for a group of pools. Dealers may also be given the ability to indicate an axed bid/offer to their customers in real time with a single click. Additionally, the dealer software may be structured so that multiple users across trading and sales can work side-by-side and view the inputs of other users in real time.

Dealer Software Dollar Price Matrix: In various embodiments, this feature allows a trader to arrive at a single weighted average bid or offer on a group of bonds when a customer requests an all-or-none (AON) quote. In some embodiments, the functionality of this feature is as follows: If a user clicks into the AON quote field, a secondary weighted average window appears allowing the user to enter quotes on each line item. The software calculates the weighted average bid/offer for the entire group based on the individual bids/asks and the current face of each bond. If items are designated as non-standard settle, the user can leverage the dealer software carry calculator for each line item. In some embodiments, quote types that are supported include: Swap vs TBA; Outright: Pay-up; and Dollar Price. In one embodiment, a client may choose to request a quote type of dollar price instead of pay-up on specified pool trades. This allows the client to know the all-in price up front and they can avoid negotiating a spot after the trade is executed on spread. For all dollar price quote requests that are for TBA settlement, the dealers can be given the ability to input a pay-up to arrive at an all-in dollar price bid or offer. Dealer software tickets can have a pay-up column for items that are dollar price protocol. This allows dealers to input a pay-up bid or offer but present a dollar price that they can send through to the client.

Dealer Software Carry Calculator: When the seller or buyer of a specified pool requests a bid or offer for a settlement date that is prior to the pool's standard settlement date as defined by the Securities Industry and Financial Markets Association (SIFMA), a dealer must evaluate the principal and interest that is lost or gained (carry) by transferring ownership of the bond ahead of standard settlement. In some embodiments, the carry calculator is an analytical tool embedded directly into the specialized dealer software which provides the carry valuation of a bond in ticks (32nds) based on user inputs and static information queried from a system database. In some embodiments, data required for calculation includes: Financing Rate (BPS); conditional prepayment rate (CPR) (sourced, e.g., from eMBS or custom input); TBA Price (sourced from composite or custom input); Standard Settle Quote; Day Count (difference between pool settlement and standard settlement). In one embodiment the carry can be rounded to the nearest 1/8^{th} or the nearest 1/16^{th}.

Pool Description Validation: In some embodiments, to enhance the validity of user-defined pool descriptions (pool story), verification logic may be implemented to confirm that the pool satisfies the criteria of the description. When a user selects a pool description from the drop-down menu or pastes in a pool description, the software will query a pool database (e.g., eMBS data) to validate the attribute associated with the pool description and visually indicate to the customer and to the dealer that the description is verified. There are certain scenarios in which a pool may qualify for multiple pool descriptions. For instance, an 85K MAX could also be a FICO<700. In this instance, either description would be considered valid. In some embodiments, if the characteristics of the pool do not meet the description that the customer has selected, they will not be able to send the request until changing the story/description or in one embodiment they will be provided with a notification regarding the deficient story/description.

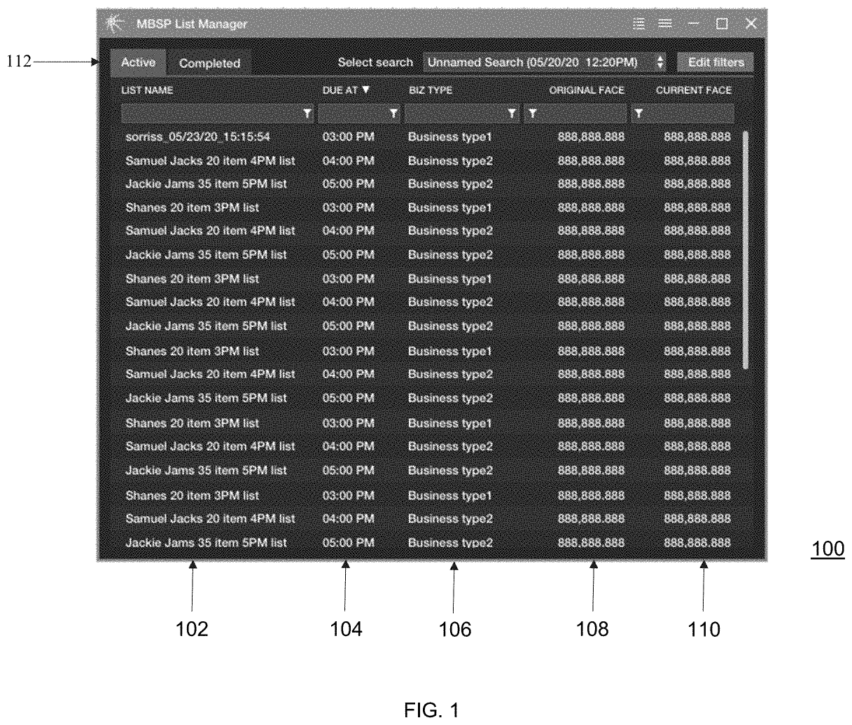

List Manager: As more of the specified pool market is digitized, there will be increased demand from buy-side institutions for transparency into lists that are being traded on the system. Currently, buy-side institutions rely on dealers to forward them specified pool lists because they do not receive anything directly from an originator or other institutional sellers. This process is extremely manual for dealers as they typically need to reformat and distribute the lists they receive to their end accounts. It is also a very manual and cluttered process for end accounts as they receive multiple communications (emails, Bloomberg messages, chats, etc.) from multiple dealers referencing the same list with little identification or differentiation. To streamline this process for both dealers and end accounts, in some embodiments a List Manager may be provided that can act as a centralized public queue for all lists that are out for auction on the electronic trading platform. The list functionality may include a public/private toggle so that a user can specify whether or not their list will be publicly disclosed in the List Manager when sent out on the trading platform. In some embodiments, any user who has MBS view/trade access will be able to open a list from the manager to view basic details about the bonds that are out for auction. The List Manager may also have filters so that users can target specific pool characteristics and create a curated queue. FIG. 1 is a screenshot of user interface 100 for a List Manager according to certain embodiments of the present invention. Through this user interface users can see the origination and are given the option to bid on the list through a dealer of their choice. This provides the user with increased flexibility and transparency. As can be seen in FIG. 1 in this embodiment user interface 100 can include a variety of columns for the user including a list name 102, due at time 104, type of business 106, original face value of the list 108, and the current face value of the list 110. In one embodiment, the listing on the interface can also be toggled between active or completed lists by selecting the appropriate button 112. When the user selects a line item in the list they can then bid through the dealer of their choosing.

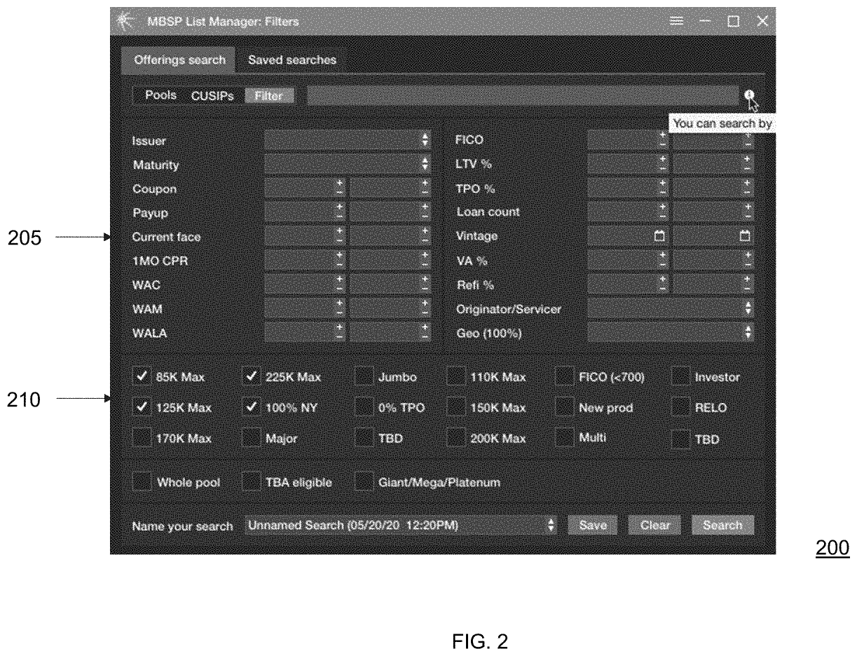

FIG. 2 is a screenshot of user interface 200 that shows non-limiting examples of List Manager filters, according to certain embodiments of the present invention. As can be seen in FIG. 2, in this example, the user can filter results based on Issuer, Maturity, Coupon, Payup, Current Face Value etc. by filling in search criteria in section 205 They can also be filtered based on a dollar amount, Fico score or other criteria by using the checkbox feature in Section 210. Once the filter search is performed the user is preferably brought back to interface 100 with the filtered results displayed for action by the user.

End-to-End List Trading: In some embodiments, end-to-end list trading may be provided, for example, as extended functionality of the List Manager. This functionality can keep all trade activity from a single list within the trading platform ecosystem. In certain embodiments, when a buy-side user (end account) opens a list from the List Manager, they will have the option to enter quotes and pass them through the trading platform software to a particular dealer. The dealers can have a quote aggregator tool built into the dealer software that will allow them to manage quotes received from multiple end-accounts. Dealers will have the option to pass end-account bids (in addition to other bids) through to the seller on behalf of the end-account. If the seller awards bonds to a dealer that are a result of an end-account bid, that dealer will execute both sides of the trade (one with each counterparty) to facilitate end-to-end execution, all within the trading platform.

In customer (buy-side) list trading software, enhanced grouping functionality may be provided that allows a user to define group level trading protocols rather than at the list level. Lists may have commingled/multiple trading protocols. To reduce ticket costs and trading errors, a net spotting and net hedging tool may be provided that aggregates TBA spot requests and hedges by benchmark, and/or by dealer. Embodiments of the present invention may also support pre-CUSIP trading, meaning that a firm can trade a bond as a stipulated (“stip'd”) TBA “shell” prior to securitization. In addition, in some embodiments, as part of the execution and negotiation process, customers may be given the ability to provide participating dealers with pre-established, validated feedback on the competitiveness of their quotes, cementing the integrity of communication during trading.

Systems and methods are described herein that provide list trading functionality for the mortgage origination sector. Currently, MBS originators or other users pool loans and submit lists to the primary and regional dealer community via custom spread sheets. The existing process is highly inefficient and manually intensive. Embodiments of the present invention can overcome various technical problems in the existing process, and can provide improved list trading functionality as a new product on an existing institutional platform. In various embodiments, an origination platform (“MBSP”) of the present invention may comprise, for example, one or more of the functions/features outlined in Table 1 and described further below.

TABLE 1

| Feature | Detail |
|---|---|
| Bid lists | Support BID lists |
| Instruments | Stip'd TBA - Pre-CUSIP pools |
| | Spec pools - with CUSIP |
| Trade types | Outright |
| | Swap vs. TBA |
| Grouping | Each list can be organized into different |
| | sub-lists (groups) |
| | Each sub list can have its own protocol options |
| List/Sub | List type |
| list options | Individual |
| | AON |
| | Quote type |
| | Pay up |
| | $ Price |
| | Trade type |
| | Outright |
| | Swap vs. TBA |
| Axe indications | Ability for a dealer to indicate an Axe along with a |
| Tick increments | 1/16^{th} of 32^{nd} |
| | Ex: 1-001 1/16 |
| Timing | Due in/Due at |
| | ASAP |
| Negotiation | Single dealer counter - Ability to execute at |
| features | different price than provided by the dealer |
| | (typically the COVER price) |
| | Improve - Requesting a better price from one |
| | or more dealers not at the best level (i.e. |
| | covering) |
| | Tie break - Requesting a better price from one |
| Spotting options | Spot later |
| | Spot Immediate |
| | System automatically sends off a spot |
| | request to the dealer |
| | Dealer provides a spot level to the |
| | client |
| | Client can ACCEPT or COUNTER |
| | the spot level |
| | Auto accept spot |
| | System requests the spot as soon as the bid is |
| | hit and accepted |
| | Dealer sends a spot price |
| | System accepts the spot as long as |
| | quote is within 5% of composite |
| | Net Spotting |
| | Available after the list is complete |
| | Client requests a single spot price from a |
| | dealer for all bonds benchmarked against |
| | the same TBA |
| | Net Hedging |
| | Available after the list is complete |
| | Client requests a single spot price and |
| | hedge amount for all bonds benchmarked |
| | against the same TBA |
| | Hedge amounts are aggregated by |
| | benchmark, per dealer |
| Post trade | Client option to provide covers to all or |
| communication | participating dealers |
| | Download of auction results including traded |
| | price and cover |
| Dealer software | Notification |
| | List ticket |
| | Spotting |
| | Trade blotter |
| | Axe indications |

### New Product—MBSP

In some embodiments, originator pools may be a new product group (PGRP) in the origination platform. Authorization can be independent of MBS View/Trade. In some embodiments, a list can consist of any combination of line items of the following security types: originator pools; stip'd TBAs; swaps (stip'd TBAs vs TBA benchmark). In some embodiments, each will be traded under the same PGRP.

In some embodiments, dealers may be required to enable a client for trading. For example, in some embodiments, dealers may be given the ability to prevent a client from trading on swap vs. TBA. In some embodiments, if this option is selected and the client selects “SWAP” on any line item, the dealer cannot be selected on that line item.

In some embodiments, the system and method can support multiple line items and dealers, and can provide quote updates at sub-second frequency (e.g., every 1/5 second).

In some embodiments, regional dealers may be able to participate as dealers on the originator platform while maintaining customer status on the TBA platform. A dealer block bray be provided to prevent trading on swap with specific customers.

### User Interface Components

Various embodiments of the present invention provide user interface (UI) components as follows. The client software may include, for example, one or more of the following screens: list ticket/set up; negotiation; response panel; blotter; net spotting; net hedging; trade detail; and /or recap. The dealer software may include, for example, a list blotter screen, list ticket screen, and/or spot ticket screen. The functionality of these screens is described below.

The list ticket/set up screen may provide one or more of the following functions: ability to organize into different sub-lists; dealer selection per line item; column configuration; pool description; sorting; list title; due in/due at; ASAP.

The negotiation screen may provide one or more of the following: organization as list ticket; column configuration; axe indication; tie indication; ability to see all quotes from a single dealer; ability to see all quotes per line item; ability to see all quotes; ability to see a summary of best and cover quotes; ability to see quote history; response panel (countering; improve; tie break; notifications); spotting.

The response panel may drill down into a line item; display all responses in a particular order (e.g., from best to worst); and/or provide functionality to negotiate the price with one or more dealers.

The spot blotter screen is provided for individual spots; net spotting; and net hedging. The net spotting screen can organize accepted trades by counterparty and benchmark multiple items by requesting a single price on benchmark and may optionally provide the ability to modify the total hedge quantity.

The trade detail screen can provide the ability to print a trade summary comprising, for example, some or all of the following information: direction; pool quantity (original and current face); pool factor; pool description (description, ticker, coupon); pool CUSIP (if available); trade type; quote type; spot timing; user info (trader name, user ID); trade date; trade time; settle date; counterparty; sales coverage; traded level; pool price (dec); pool price (32^{nd}); principle, accrued, net; cover quote; TBA info (TBA description, TBA quantity, TBA settle, TBA price (dec), TBA price (32^{nd}), TBA CUSIP, TBA direction, TBA principal, TBA total); competing quotes.

The recap screen can display all quotes at the time of execution and/or include a tool tip showing all price improvements for a given item.

In the dealer software, the list blotter screen may display a single entry for each list, and the trader will open a list ticket or spot request by clicking on a line item. The list ticket may be used for quoting items on the list, and may comprise a configurable column. Traders and salespeople will have the ability to query items that are either contained in a list i.e. CUSIP and/or Pool number or filter the list blotter by querying a customer name or list name. These filter tools support partial matches.

### Stip'd TBA

In some embodiments, there may be two different work flows in the originator space: with CUSIP and Pre-CUSIP. Some originators sell pools on a “Stip'd TBA” basis. The instruments are not known or available on vendor platforms such as by not limiting example eMBS, Bloomberg, or Tradeweb. In these cases, the client supplies the necessary data to describe pools being sold.

In some embodiments, the columns/attributes required for sending a Stip'd TBA to list may be as shown in Table 2. The identifier used for post trade purposes)) may be ‘TBACusip_description’. The tables for ticker, description, amortization period, original term, days to first pay, and default term for FNMA, FHLMC, and GNMA (also known as Fannie Mae, Freddie Mac, and Ginnie Mae respectively) may be as shown in Tables 3-5, respectively.

TABLE 2

| Column | Sample Data | Optional Names | Rq'd for |
|---|---|---|---|
| Product Type | MBSP | | Yes |
| Ticker | FNCL | | Yes, if issuer |
| | | | is absent |
| Settle | MM/DD/YY | Settle, SD, | Yes |
| | | Settlement, Settle | |
| Agency | FNMA, FHLMC, | Issuer | Yes, if |
| | GNMA, GNMA II | | Ticker is |
| | | | absent |
| Description | LLB, 20 YR | Bond Spec | |
| | 85K MAX | | |
| Term | 360, 180, 30 Y, 15 Y | Maturity | |
| Coupon | 3.0, 3.5 | CPN | Yes |
| Original Face | 3500000 | Original Face, | |
| | | Orig UPB, | |
| Order ID | 9233B | Cmmt # | |
| Factor | 1.00000000 | Factor | |
| Issue Type | | Type | |
| Sell Var % | 1 | sell var | |
| Buy Var % | 0.01 | buy var | |
| Hedge Amt | 3500000 | BUY BACK | |
| TBA | FN 2.5 Nov | BENCHMARK | |

TABLE 3

| | | | | Days | |
|---|---|---|---|---|---|
| | | | | To | |
| Market | | Amort | | First | DEFAULT |
| Ticker | Description | Period | Term | Pay | TERM |
| FNCI | FNMA CONV INTERMEDIATE TERM 15 YR | 180 | 180 | 54 | 15 YR |
| FNCJ | FNMA CONV INTERMEDIATE TERM 15 YR - JUMBO-CONFORMING | 180 | 180 | 54 | 15 YR |
| FNCK | FNMA CONV LONG TERM 30 YR - JUMBO-CONFORMING | 360 | 360 | 54 | 30 YR |
| FNCL | FNMA CONV LONG TERM 30 YR | 360 | 360 | 54 | 30 YR |
| FNCT | FNMA CONV LONG TERM 20 YR WITH CL PREFIX | 240 | 240 | 54 | 20 YR |
| FNCN | FNMA CONV SHORT TERM 10 YR | 120 | 120 | 54 | 10 YR |
| ENCQ | FNMA CONV LONG TERM 30 YR OR LESS HARP LTV >105 <= 125 | 360 | 360 | 54 | 30 YR |
| ENCQ | FNMA CONV LONG TERM 20 YR OR LESS HARP LTV >105 <= 125 | 240 | 240 | 54 | 30 YR |
| ENCR | FNMA CONV LONG TERM 30 YR OR LESS HARP LTV >125 | 360 | 360 | 54 | 30 YR |
| ENCR | FNMA CONV LONG TERM 2O YR OR LESS HARP LTV >125 | 240 | 240 | 54 | 30 YR |
| FNCT | FNMA CONV INTERMEDIATE TERM 2O YR | 240 | 240 | 54 | 20 YR |
| FNCV | FNMA CONV INT TERM 15 YR OR LESS HARP LTV >105 <= 125 | 180 | 180 | 54 | 15 YR |
| FNCW | FNMA CONV INT TERM 15 YR OR LESS HARP LTV >125 | 180 | 180 | 54 | 15 YR |

TABLE 4

| | | | | Days | |
|---|---|---|---|---|---|
| | | | | To | |
| Market | | Amort | Orig | First | |
| Ticker | Description | Period | Term | Pay | DEFAULT |
| FGLMC | FHLMC GOLD 30 YR | 360 | 360 | 44 | 30 YR |
| FGCN | FHLMC GOLD 10 YR IN 15 YR | 120 | 120 | 44 | 10 YR |
| FGCI | FHLMC GOLD 15 YR | 180 | 180 | 44 | 15 YR |
| FGTW | FHLMC GOLD 20 YR | 240 | 240 | 44 | 20 YR |
| FGT4 | FHLMC GOLD 15 YR - JUMBO- | 180 | 180 | 44 | 15 YR |
| FGT5 | FHLMC GOLD 20 YR - JUMBO- | 240 | 240 | 44 | 20 YR |
| FGT6 | FHLMC GOLD 30 YR - JUMBO- | 360 | 360 | 44 | 30 YR |
| FGU4 | FHLMC GOLD 15 YR LTV >105 <= 125 | 180 | 180 | 44 | 15 YR |
| FGU4 | FHLMC GOLD 10 YR IN 15 YR | 120 | 120 | 44 | 15 YR |
| FGU5 | FHLMC GOLD 20 YR LTV >105 <= 125 | 240 | 240 | 44 | 20 YR |
| FGU6 | FHLMC GOLD 30 YR LTV >105 <= 125 | 360 | 360 | 44 | 30 YR |
| FGU7 | FHLMC GOLD 10 YR IN 15YR | 120 | 120 | 44 | 15 YR |
| FGU7 | FHLMC GOLD 15 YR LTV >125 | 180 | 180 | 44 | 15 YR |
| FGU8 | FHLMC GOLD 20 YR LTV >125 | 240 | 240 | 44 | 20 YR |
| FGU9 | FHLMC GOLD 30 YR LTV >125 | 360 | 360 | 44 | 30 YR |

TABLE 5

| | Market | | Amort | Orig | Days To | |
|---|---|---|---|---|---|---|
| Product | Ticker | Description | Period | Term | First Pay | DEFAULT |
| GNMII30M | G2JM | GNMA II 30 YR SF - JUMBO- | 360 | 360 | 49 | 30 YR |
| GNMII15M | G2JM | GNMA II 15 YR SF - JUMBO- | 180 | 180 | 49 | 30 YR |
| GNMII15C | G2JO | GNMA II CUSTOM 15 YR PLATINUM | 180 | 180 | 49 | 15 YR |
| GNMII15M | G2JO | GNMA II 15 YR PLATINUM SINGLE | 180 | 180 | 49 | 15 YR |
| GNM15 | GNJO | GNMA I 15 YR PLATINUM SINGLE | 180 | 180 | 44 | 15 YR |
| GNMII30C | G2SF | GNMA II 30 YR SINGLE FAMILY - | 360 | 360 | 49 | 30 YR |
| GNMII15C | G2JO | GNMA II 15 YR SF MIDGETS - | 180 | 180 | 49 | 15 YR |
| GNMII20C | G2TW | GNMA II 20 YR SF MIDGETS - | 240 | 240 | 49 | 20 YR |
| GNMII20M | G2TW | GNMA II 20 YR SF MIDGETS - | 240 | 240 | 49 | 20 YR |
| GNMII15M | G2JO | GNMA II 15 YR SF MIDGETS - | 180 | 180 | 49 | 15 YR |
| GNMII30M | G2SF | GNMA II 30 YR SINGLE FAMILY - | 360 | 360 | 49 | 30 YR |
| GNM30 | GNSF | GNMA I 30 YR SINGLE FAMILY | 360 | 360 | 44 | 30 YR |
| GNM10 | GNCN | GNMA I 10 YR SINGLE FAMILY | 120 | 120 | 44 | 10 YR |
| GNM15 | GNJO | GNMA I 15 YR SINGLE FAMILY | 180 | 180 | 44 | 15 YR |
| GNM20 | GNTW | GNMA I 20 YR SINGLE FAMILY | 240 | 240 | 44 | 20 YR |

### List Set-Up UI

Clients typically spend time formatting spread sheets to make it easy for the dealers to interpret the content and provide accurate prices. The list ticket in the origination platform described herein preferably supports an ability to easily organize the items into logical, user-defined sections.

In some embodiments, in the list entry ticket the user can partition a list into groups of one or more line items. Each group can be negotiated individually, although the negotiation protocol (due-in/due-at/asap) and timing parameters are the same across all groups in a list. The negotiation of a list that is partitioned into groups can occur in a single UI window for both buy side and sell side. In some embodiments, the user can override the following list-level parameters at the group level: all or none (AON)/individual; Pay up/Price; Outright/Swap. In some embodiments, list items can exist without being part of a group. Users may assign items to groups in the UI or via initial spread sheet submission. Within the UI, this can be done by dragging and dropping items from one group to another. Moreover, in some embodiments, the UI may optionally support <Shift>±Click and <CTRL>+Click to select a range within a group or multiple rows, respectively, to then drag and drop to a different group. The UI can allow sorting any column, but the primary sort is preferably logical grouping. The UI may also provide the ability to title lists and their groups in the UI or via spread sheet paste, as shown, for example, in Table 6. Since a user can paste an individual item that is not associated with a group in a spread sheet, a default group (e.g., named ‘DEFAULT’) may act as the receptacle for all items that aren't in a group.

TABLE 6
List 1 - Wells 30 Y Origination Due @ 11 am

List 1a - 5 bonds, Individual, On Swap
List 1b - 5 bonds, Individual, Outright,
List 1c - 5 bonds, Individual, Outright,
List 1d - 2 bonds, AON, On Swap
List 1e - 2 bonds, AON, Outright, Pay-
List 1f - 2 bonds, AON, Outright, SPrice

In some embodiments, list level properties and parameters may be as shown in Table 7. Sub list level parameters may be as shown in Table 8. All items within a group preferably share the same group level parameters. In some embodiments, list set up columns may be, for example, as shown in Table 9. In some embodiments, list set up may include number of dealers selected.

TABLE 7

| | | User |
|---|---|---|
| Name | Comments/Options | Pref |
| List description | Free form text field used to describe the list | N |
| | to the sell side | |
| | Must appear on the DS ticket | |
| Due in/due | Client may specify a time in minutes from the | V |
| at/ASAP | set time or a specific time of day | |
| Trading time | Toggle the amount time allowed for execution | V |
| Spotting | Immediate | Y |
| | Later | |
| Auto accept spot | Option to auto accept spot within 5% of the | Y |
| | composite may be supported | |
| Cover Protocol | Option to trade with the best dealer at a pre- | Y |
| | defined cover differential. | |

TABLE 8

| Name | Name | Control |
|---|---|---|
| Group type | Individual/AON | Toggle |
| Quote type | Swap vs TBA/Outright Pay up/$ Price | Drop |
| | | list |

TABLE 9

| Name | Header | Req | Example | Control | Comments |
|---|---|---|---|---|---|
| Item # | # | Y | 1, 2 . . . n | | System will number |
| | | | | | each item on the list |
| | | | | | from 1 to n. |
| B/S | B/S | Y | S | Toggle button | Should default to |
| | | | | | SELL |
| CUSIP | CUSIP | N | 31328AB5 | Text field | CUSIP is not |
| | | | | | required if |
| | | | | | trading “Pre- |
| | | | | | CUSIP” |
| Ticker | TICKER | Y | FGLMC | Auto complete | See section |
| | | | | | Ticker List |
| Description | DESCRIP | Y | 100% REFI | Auto complete | A dyuamic/changiug |
| | TION | | 95-100 | | list of classifications |
| | | | | | that describe the |
| | | | | | underlying pool, |
| | | | | | such as, but not |
| | | | | | limited to: |
| | | | | | 85KMAX, 110K |
| | | | | | MAX, 125K MAX, |
| | | | | | 1 SOK MAX, 175K |
| | | | | | MAX, 200K MAX, |
| | | | | | 225K MAX, 100% |
| | | | | | NY, 100% TX, 100% |
| | | | | | FL, 100% CA, 100% |
| | | | | | PR, FICO (<700), |
| | | | | | INVESTOR (100% |
| | | | | | INVESTOR), CQ, |
| | | | | | CR, CV, CW, T4, T5, |
| | | | | | T6, T9, U4, U5, U6, |
| | | | | | U7, U8, U9, JUMBO, |
| | | | | | MIDGET, 10 YR, |
| | | | | | 20 YR, 20 YR 85K |
| | | | | | MAX, 20 YR 110K |
| | | | | | MAX, 20 YR 150K |
| | | | | | MAX, SEASONED, |
| | | | | | MAJOR, MULTI, |
| | | | | | NEW PROD, |
| | | | | | RURAL HOUSING, |
| | | | | | LTV, 100% REFI, |
| | | | | | 100% REFI 70-80, |
| | | | | | 100% REFI 80-90, |
| | | | | | 100% REFI 90-95, |
| | | | | | 100% REFI 95-100, |
| | | | | | HFA, MHA 80, MHA |
| | | | | | 90, MHA 100, RELO |
| Coupon | CPN | Y | 3.5 | Numeric input | |
| Original | ORIG | Y | 88,888,888,888 | Numeric input | Number is not |
| Face | FACE | | | | scaled Numeric |
| | | | | | input -- MAX = |
| | | | | | 88,888,888,888 |
| Sell | SELL | N | 8.01% | Numeric input | Percentage amount |
| Variance | % VAR | | .01% | | that the dealer can |
| | | | | | expect the quantity |
| | | | | | to change |
| TBA | BENCHMA | Y | GD 3.5 Sep | Drop down or | Required if RFQ |
| | RK | | | auto complete | ON value^{::::} Pay-up |
| | | | | | If RFQ ON value = |
| | | | | | PRICE, then hide |
| | | | | | or show SPRICE in |
| | | | | | the column |
| Hedge | HEDGE | Y | 88,888,888 | Numeric input | If not provided, |
| Amount | AMT | | | | defaults to the |
| | | | | | Original Face value |
| | | | | | rounded down to |
| | | | | | the nearest million |
| Buy | BUY % VAR | N | 8.01% | Numeric input | Percentage amount |
| Variance | | | .01% | | that the dealer can |
| | | | | | expect the quantity |
| | | | | | to change |
| Settle Date | SETTLE | Y | MM/DD/YYYY | Calendar | |
| | | | | control | |
| Client order | ORDER ID | N | | Alpha numeric | Used by the client as |
| ID | | | | | an internal |
| | | | | | identifier for each |
| | | | | | pool |

The fields listed below are pool characteristics and may be provided by the user or
eMBS data if the client provides

| | | | | | |
|---|---|---|---|---|---|
| Pool# | POOL# | N | J37358 | | 6 character |
| | | | | | alphanumeric |
| Weighted | WAC | N | 8.888 | Numeric input | |
| average | | | | | |
| coupon | | | | | |
| Average | ALS | N | 888,888 | Numeric input | Integer |
| Loan Size | | | | | |
| Weighted | WAM | N | 365 | Numeric input | Maturity expressed in |
| Average | | | | | whole months (Integer) |
| Maturity | | | | | |
| Weighted | WALA | N | 888 | Integer | Average age of |
| average | | | | | underlying loans in |
| loan age | | | | | months (integer) |
| Average | AOLS | N | 888,888 | Numeric input | Integer |
| outstanding | | | | | |
| loan size | | | | | |
| Weighted | WLTV | N | 88 | Numeric input | Integer |
| average | | | | | |
| loan to | | | | | |
| value | | | | | |
| FACTOR | FACTOR | N | 0.25167921 | Numeric input | Ratio of original face to |
| | | | | | current face |
| | | | | | If the factor is 1, do not |
| | | | | | show trailing zeros |
| FICO | FICO | N | 888 | Numeric input | |
| Max loan | MAX LN | N | 888,888,888 | Numeric input | |
| size | SZ | | | | |
| Prefix | PREFIX | N | CI | | |
| Issue Date | ISSUE DT | N | MM/DD/YY | Label | |
| Maturity | MTY DT | N | MM/DD/YY | Label | |
| Whole pool | WHOLE | N | 88,888,888,888 | Label | |
| face | POOL | | | | |
| Loan to | LTV | N | 88% | Label | |
| Max Geo | MAX GEO | N | 88% CA | Label | Percentage and state |
| State | ST | | | | abbreviation |
| TPO % | TPO % | N | 88.8% | | |

Items in the UI may be associated with a positive integer value. Those values can be ordered from top to bottom across the whole list. Numbers may be assigned to each line item in the client entry ticket according to top-down order. At the point it is sent, the item numbers may be fixed and associated with their respective items throughout the negotiation. If the customer chooses to select only a subset of the items, then the numbering of the items in negotiation will have gaps (e.g., if the client sent only items 1, 3, 5, 7 of a ten item list, then the numbers of the line items will be 1, 3, 5, 7). The recap page preferably shows the line numbering that was shown during the negotiation. If the user resubmits a list, then the line items may retain their numbers from the previous list. However, if the user then pastes in more line items, the numbering may reset completely.

Preferably, the trader can paste from clipboard by right clicking within existing group, or clicking paste button at the bottom of the list. Certain embodiments of the system can be flexible with respect to the column headers provided by clients; can accept upper/lower/mixed case; and/or can support different alias column headers and have the ability to add to the list when necessary without requiring a full release. In some embodiments, if trading with CUSIP, the user may be allowed paste either CUSIP or POOL#. The UI can allow users to specify the TBA and TBA hedge quantity as part of the pasting template and/or to provide an internal security/order ID for line items in paste. In some embodiments, when pasting using right click, all items go to the right-clicked group (as bottom item of the group) regardless of whether clipboard items specify a group. In some embodiments, when pasting using the “Paste” button: for clipboard items that do not indicate groups, all items go to the default group; and clipboard items that indicate groups, send those items to respective existing groups with matching names and create new groups where no group currently exists with matching name. The UI may also provide Right Click Menus Support. For example, in some embodiments, for right click on a pool row: “Remove pool” deletes a single line item; “Move to group” reveals a submenu of groups the item can be moved to; and “Paste from clipboard” follows the rules described above, In some embodiments, for right click on a group header or a group summary row: “Rename Group” allows user to rename group; “Create group” creates a new empty group; “Move all items” reveals a s bmenu of groups the item can be moved to and deletes current group; “Delete group” deletes the group and all items in it; and “Paste from clipboard” follows the rules described above.

In some embodiments, Excel Export may also be incorporated. Thus, the UI can provide the ability to export the set up screen so that if necessary, the originator can send an Excel sheet to regional dealers that may not be on the system.

### Ticker List

Tables 10-12 show ticker lists for FHLMC, FNMA, and GNMA, respectively.

TABLE 10
FHLMC

| | | | |
|---|---|---|---|
| FG14 | FGT3 | FGHC | FH14 |
| FG2M1 | FGT4 | FGK2 | FH23 |
| FGCI | FGT5 | FGK3 | FH2M1 |
| FGCN | FGT6 | FGK5 | FH2M3 |
| FGCO1 | FGT9 | FGL1 | FH68 |
| FGCO3 | FGTW | FGL2 | FH7B |
| FGF6 | FGU2 | FGLM | FHCA |
| FGF7 | FGU3 | FGMA | FHCI |
| FGG7 | FGU4 | FGMB | FHCN |
| FGH0 | FGU5 | FGMC | FHCO1 |
| FGH1 | FGU6 | FGMM | FHCO3 |
| FGH2 | FGIJ7 | FGMN | FHHD |
| FGH3 | FGU8 | FGP1 | FHLM |
| FGH4 | FGU9 | FGP4 | FHMD |
| FGH5 | FGV2 | FGP5 | FHMF |
| FGH6 | FGV3 | FGP6 | FHRL1 |
| FGH7 | FGV4 | FGRL1 | FHRL3 |
| FGH8 | FGV5 | FGRL3 | FHS |
| FGHA | FGW0 | FGW3 | |
| FGHB | FGW1 | FH13 | |

TABLE 11
FNMA

| | | | |
|---|---|---|---|
| FN21 | FNGI | FNKI | FNPL |
| FN2L | FNGL | FNKL | FNQI |
| FN2M | FNH2 | FNMA | FNQN |
| FNCA | FNHI | FNMI | FNQT |
| FNCB | FNHL | FNML | FNR1 |
| FNCI | FNHN | FNMN | FNR2 |
| FNCJ | FNHS | FNMT | FNR3 |
| FNCK | FNHT | FNNA | FNRE |
| FNCL | FNI1 | FNNB | FNM |
| FNCN | FNI2 | FNNC | FNTK |
| FNCP | FN13 | FNND | FNTQ |
| FNCQ | FNI4 | FNNE | FNTT |
| FNCR | FNII | FNNF | FNU1 |
| FNCT | FNIL | FNNJ | FNU2 |
| FNCV | FNIOF | FNNP | FNU3 |
| FNCW | FNJI | FNNQ | FNU4 |
| FNCZ | FNIL | FNOI | |
| FNEL | FNJM | FNOL | |
| FNFL | FNJZ | FNPI | |

TABLE 12
GNMA

| | |
|---|---|
| G2FS | GNCS |
| G2JM | GNJO |
| G2JO | GNMH |
| G2MH | GNPL |
| G2SF | GNSF |
| G2TW | GNSN |
| GNCL | GNTW |
| GNCN | |

### Description List

In some embodiments, authorized support representatitives may manually define a function mapping clients' descriptions into industry standardized descriptions. For example: ‘85K MAX’ to U8′; ‘110K MAX’ to ‘U9’; ‘U5’ to ‘MHA 100’; ‘U6’ to ‘RELO’; etc. A single many-one mapping will preferably exist for all clients and may be defined iteratively over time. In some embodiments, the description map can be used to automatically convert descriptions when the user pastes a list. To validate user-defined pool descriptions, in one embodiment logic is used to verify that the pool satisfies the criteria of the description. When a user selects a pool description from the dropdown menu or pastes one in a pool description, it can be validated by cross-referencing with the exemplary conditions listed in Table 13 below.

TABLE 13

| Description | Condition |
|---|---|
| 85K MAX | Max Loan Size <=85K |
| 110K MAX | Max Loan Size <=110K and >85K |
| 125K MAX | Max Loan Size <=125 and >110K |
| 150K MAX | Max Loan Size <=150K and >125K |
| 175K MAX | Max Loan Size <=175K and >150K |
| 200K MAX | Max Loan Size <=200K and >175K |
| 225K MAX | Max Loan Size <=225K and >200K |
| 250K MAX | Max Loan Size <=250K and >225K |
| FICO (<700) | FICO <700 |
| LTV 80-90 | Loan to Value ratio is >=80 and <90% |
| LTV 90-95 | Loan to Value ratio is >=90 and <95% |
| LTV 95-100 | Loan to Value ratio is >=95 and <100% |
| LTV 100-105 | Loan to Value ratio is >=100 and <105% |
| LTV 105-125 | Loan to Value ratio is >=105 and <125% |
| LTV >125 | Loan to Value ratio is >=125% |
| NEW PROD | Origination Date is in current month, or WALA <1 |
| JUMBO | CK/CJ/G2JM/T6/T4/T5/T9 Prefix |
| MAJOR | Issued by Fannie Mae where Seller = MULTIPLE & |
| | Pool # begins with “MA” |
| MULTI | Issued by Ginnie Mae with Issuer= GNMA |
| | MULTIPLE ISSUER or Issued by Freddie Mac with |
| | Seller = MULTIPLE & Pool # Ranges from |
| | RA0000-RA0999/RB5000-RB999/ |
| | RC0000-RC0999/RD5000-RD9999 |
| SEASONED | WALA >24 |
| 100% NY | GEO 1 = 100% NEW YORK |
| 100% TX | GEO 1 = 100% TEXAS |
| 100% FL | GEO 1 = 100% FLORIDA |
| 100% CA | GEO 1 = 100% CALIFORNIA |
| 100% PR | GEO 1 = 100% PUERTO RICO |
| INVESTOR | invest_pct = 100% |
| | (Occupancy Type: Investment Home = 100%) |
| CQ | Prefix = CQ |
| CR | Prefix = CR |
| CV | Prefix = CV |
| CW | Prefix = CW |
| U6 | Prefix = U6 or 3S |
| U7 | Prefix = U7 OR 3X |
| U8 | Prefix = U8 or 3W |
| U9 | Prefix = U9 or 3V |
| MIDGET | G2JO Ticker |
| 10 YR | FNCN Ticker |
| 20 YR | FNCT Ticker |
| RURAL | RHS = 100% |
| HOUSING | |
| 100% REFI | Loan Purpose: Refinance = 100% & LTV >=70 and |
| 70-80 | <80 |
| 100% REFI | Loan Purpose: Refinance = 100% & LTV >=80 and |
| 80-90 | <90 |
| 100% REFI | Loan Purpose: Refinance = 100% & LTV >=90 and |
| 90-95 | <95 |
| 100% REFI | Loan Purpose: Refinance = 100% & LTV >=95 and |
| 95-100 | <100 |
| RELO | Prefix = RE |
| MHA80 | Pools that = 100% Refi and <=80 LTV |
| MHA90 | Pools that = 100% Refi and <=90 LTV |
| Month | Issued by Fannie Mae where Seller = Multiple & |
| Defined Major | pool # begins with “MA”& CUSIP Issue Date = 1 of |
| | 6 available Major Months available in current pool |
| | description library |
| Month | Issued by Ginnie Mae with Issuer = GNMA |
| Defined Multi | MULTIPLE ISSUER or Issued by Freddie Mac with |
| | Seller = MULTIPLE & Pool # Ranges RA0000- |
| | RA0999/RB5000-RB9999/RC0000-RC0999/ |
| | RD5000-RD9999 & CUSIP Issue Date = 1 of 6 |
| | available Multi Months available in current pool |
| | description library |
| 100% PIW | Appraisal Waiv % = 100% |
| GREEN | eMBS Description includes “Green” |
| GENERIC | No specific criteria |

In one embodiment in order to enhance the validity of user-defined pool descriptions logic can be implemented to verify that the pool satisfies the criteria of the description. For example, when a user pastes in a CUSIP or sends in a solicited CUSIP, the pool description defaults to the most logical description based on previously established validation waterfall logic. In the case of a pool qualifying for multiple pool descriptions, it may default to the pool description that is higher in the waterfall logic but would allow the user to change the description if they wanted to market the bond under a different/valid description. When a user selects a pool description from a drop-down menu or pastes in a pool description, a pool database can be queried to confirm the attribute associated with the pool description and visually indicate to the customer and dealer whether or not the description is valid.

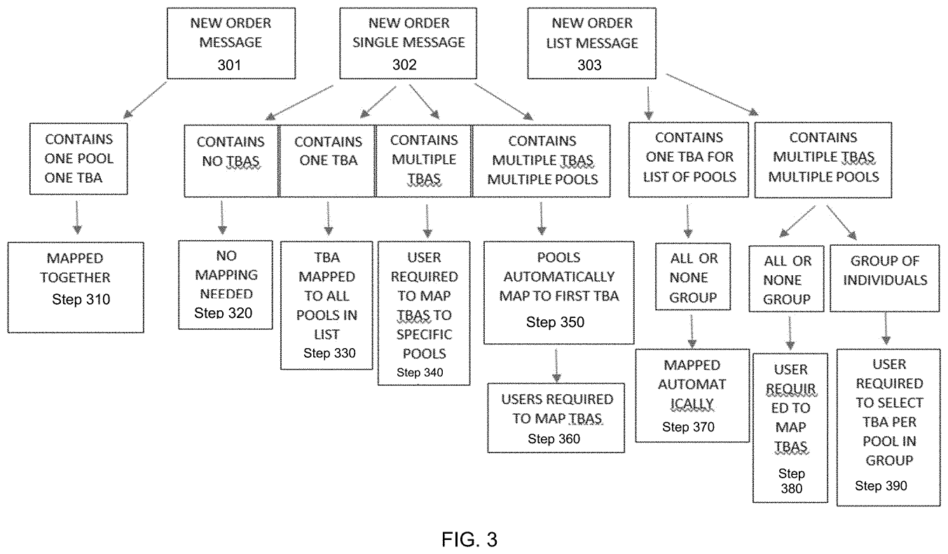

In one embodiment clients can send orders from their Order Management Systems (“OMS”) via a message flow as depicted in FIG. 3 and further discussed below. Any solicited messages are sent to a user's docket which lists for the user any new orders sent in from an OMS. When a user launches a solicited list from their docket, they can map a TBA to a group or specified pool.

There are three categories of messages that can be used to support the order through the OMS. The first is new order message 301 which is a message for an order for one pool and one TBA together. If a message is received for one of these orders through a client's OMS, it is mapped to the customer's TBA (Step 310).

New order single message 302 is an individual order of pools and/or TBAs. This can include no TBAs, a single TBA, multiple TBAs or multiple TBAs and multiple pools. If no TBA's are sent no mapping is performed (Step 320). If TBA's are sent, after the client's OMS sends in this order type, it will display in a list that can be launched from the user's docket. If customer's OMS sends a list ID, then the pools and TBAs will be sent to that list with that list ID on the docket. If no list ID is sent then it will be sent to the default list. If a user sends multiple new order messages with the same list ID, they will flow into the same list on docket. When a user launches this list, if the list contains only one TBA, the list is defaulted to an AON and the TBA is mapped to all pools present in the list (Step 330). If the list contains multiple TBAs, the system will require the user to map the TBAs to the specific pools using a mapping interface (Step 340). If there are multiple TBAs and multiple pools, the pools will all map to the first TBA (Step 350) and this may require the users to map the TBAs using a mapping interface (Step 360).

New order list message 303 is a list order of pools with TBA(s). Where there is one TBA for a list of pools this is an AON trade and the TBA is mapped automatically (Step 370). All trade information would need to be sent via the OMS. If there are multiple TBAs and multiple pools, if it is an AON group the system will require the user to map the TBAs to the specific pools using a mapping interface (Step 380). If there is a group of individuals the user will need to select a TBA per pool in the group (Step 390).

### Negotiation

Negotiation/Quoting Protocol

In some embodiments of the present invention, for individual lists, the dealer will send a quote for each item individually. For AON lists/groups, dealers quote a single level for a whole list/group which then gets propagated to each constituent item. In one embodiment an email can be automatically generated to send out the quotes.

Due-in and Due-at protocols may be configured with one or more of the following features: Protocol is a list-level configuration; Due-in: client sets session time; Due-at: client sets time of day; When client hits/lifts after due-in/due-at time, dealer gets last look; Dealer can update levels before due-in/due-at expires; Dealer can only accept/reject during last look.

An ASAP protocol may be configured with one or more of the following features: Protocol is a list-level configuration; Client sets session time; Dealer can update quote at any time.; When client hits/lifts, dealer gets last look; Dealer can accept/reject/requote during last look.

Tick increments are supported in 1/16^{th} of 32^{nd} (e.g., 1-001 1/16). Table 14 shows the input format and corresponding decimal representations.

TABLE 14

| | Decimal |
|---|---|
| 1/16th Input Format | |
| 0-00 | |
| 0-00 1/16 | 0.001953125 |
| 0-00 3/16 | 0.005859375 |
| 0-00 5/16 | 0.009765625 |
| 0-00 7/16 | 0.013671875 |
| 0-00 9/16 | 0.017578125 |
| 0-00 11/16 | 0.021484375 |
| 0-00 13/16 | 0.025390625 |
| 0-00 15/16 | 0.029296875 |
| 1/16th Increments | |
| 0-00 | |
| 0-00 1/16 | 0.001953125 |
| 0-001 | 0.00390625 |
| 0-00 3/16 | 0.005859375 |
| 0-002 | 0.0078125 |
| 0-00 5/16 | 0.009765625 |
| 0-003 | 0.01171875 |
| 0-00 7/16 | 0.013671875 |
| 0-00+ | 0.015625 |
| 0-00 9/16 | 0.017578125 |
| 0-005 | 0.01953125 |
| 0-00 11/16 | 0.021484375 |
| 0-006 | 0.0234375 |
| 0-00 13/16 | 0.025390625 |
| 0-007 | 0.02734375 |
| 0-00 15/16 | 0.029296875 |
| 0-01 | 0.03125 |
| ⅛th Increments | |
| 0-00 | |
| 0-001 | 0.00390625 |
| 0-002 | 0.0078125 |
| 0-003 | 0.01171875 |
| 0-00+ | 0.015625 |
| 0-005 | 0.01953125 |
| 0-006 | 0.0234375 |
| 0-007 | 0.02734375 |
| 0-01 | 0.03125 |
| ¼th Increments | |
| 0-00 | 0 |
| 0-002 | 0.007813 |
| 0-00+ | 0.015625 |
| 0-006 | 0.023438 |
| 0-01 | 0.03125 |

An axe indicator can provide the ability to send an “axed quote”. For example, the UI may display an axe indication on the client viewer if the quote is axed.

Client response may be selected from one or more options, such as: improve; tie break. Each can be available in due-in/due-at/ASAP mode.

In certain embodiments, dealer countering functionality may be provided, which allows a client to send a counter to any dealer. Recipient can accept/reject/requote. Client counter level is firm at dealer until the session ends or the dealer accepts, rejects or counters. Only dealers who quoted can receive a counter. In some cases the client will trade with the dealer that has provided the best price, but execute a slightly worse price in the dealer's favor.

Price improve/tie break functionality may also be provided. For price improve, during the trading session, a client can select one or more counterparties that are not at the best level and request an improvement on their current quote. Only quoting dealers not currently best can be selected. Tie break is substantially the same as improve, except only the tied-for-best dealer can be selected.

In connection with message flows different paths can be taken with respect to due-in/due-at and ASAP negotiations with countering, improving and tie-breaker optionality. In one embodiment as part of a “due-in/due-at” negotiation protocol dealers are given a fixed amount of time to quote list inquiries that clients send, after which clients are able to “hit” dealers' quotes. The due-in protocol differs from “due-at” in that the former uses a specified length of time for dealers to quote, while the latter references a fixed time of day to determine this length of time. During the due-in/due-at phase, dealers can quote, requote, or pass. If the dealer passes, then the negotiation of that item is over for that dealer. After the due-in/due-at time expires, the dealer's quote is subject at the customer (i.e. the customer can hit the quote and the dealer would get a last look to confirm the trade). While quote is subject at the customer, the customer can ask for improvement, counter the dealer, end the trade, or hit the dealer's quote. If a customer counters or asks for improvement, the dealer can quote back or pass to end the trade, unless the customer pulls the counter, leaving the dealer's previous quote subject at the customer If the client hits the dealers quote, the dealer can accept or reject (executing the trade, or ending it, respectively).

In one embodiment a negotiation protocol can be established for list inquiries sent by clients. Once a dealer quotes on the list inquiry, the quote becomes subject at the customer. The customer has the option to request the dealer to improve their quote, counter the quote with a new level, or hit the quote. The client can send an improve request back to the dealer with the following options: winning; tied, improve quote to win; tied, jump ball; tied; not winning. The dealer can respond by passing (ending the trade) or updating the quote (making the quote subject at customer again). If the client hits the subject quote, the dealer will have a “last look” phase. The dealer can then either accept/pass the trade or update the quote (making the quote subject at customer again. During this last look phase other dealers can continue to provide quote updates and if the dealer that the client originally hit, does not respond within the last look period (e.g., 2 minutes), the client can choose to engage with the same dealer again or choose to execute on a different dealer's quote. If the client counters the subject quote with a new level, the new level is “firm” at the dealer and the dealer can either accept/pass the trade or update the quote (making the quote subject at customer again).

### Negotiation UI

Specified pool lists can be sent to a large number of participants. It is estimated that some entities will distribute their specified pool lists to an audience of at least 40 dealers. During an auction, the trader is continuously interacting with his dealer sales coverage and needs the ability to switch between different views of the responses. In various embodiments of the present invention, the negotiation screen includes some or all of the following functionality: Display the items in the same order as the ticket; Full set of columns included in a separate Excel file; Descriptive columns including one or more of: Item #, CUSIP, B/S, Ticker, Description, Cpn, Orig Face, Sell Var % (pre-cusip), Benchmark, Hedge Amt, Buy Var % (pre-cusip), Settle Date; Quote Summary columns including one more of: Tie indication, Best response, Best responder, Est. Pool price, Cover response, Est. TBA price, # of Responses/# Recipients; Dealer filter (option to snap all quotes from a single dealer into a single column). Accordingly, the platform can provide the trader a quick view of all quotes and their relative position for each item on the list. For example, at the dealer level, the UI can display: Current position (winning, covering) Distance in ticks from the best level; and Axe indication.

Additional descriptive columns may include one more of the following: Pool #, WAC, WAM, WALA, ALS, AOLS, WLTV, FACTOR, Maximum Loan Size, AX LN SZ, PREFIX, ISSUE DATE, MAT DATE, LTV, WHOLE POOL FACE, MAX GEO STATE, TPO %. Additional protocol-related columns may include one more of following: RFQ on, Outright/Swap, Spot Timing, Client Order ID, Settle Date.

In the response panel (instrument view), clicking or double clicking on a line item can reveal the response panel card. In some embodiments, the response panel displays all responses for a single item on the list. All responses are sorted from best to worst. Axe indications can be used for countering and communication with the dealer, and provide the ability to counter/offer back a dealer price (i.e., hit a dealer quote at a different level than provided). For example: Dealer BIDS—1-00+, client HITS @ 1-001 (giving back to the dealer).

General features of the negotiation UI include ability to: choose and arrange data columns; display a dealer Axe indication; export to Excel; provide pre-established feedback to a dealer; display quotes in minimum increments of 1/16^{th} of 32^{nd}; and/or show dealer price update history (e.g., via tool tip). In some embodiments, the negotiation UI may optionally indicate price improvements (e.g., via color change).

The response panel can be activated when the user clicks on an item in the negotiation screen and can display all the dealer quotes for the selected line item. Dealer responses are preferably organized from best to worst. The response panel can allow the client to perform one or more of the following actions: Execute/Hit (client can also execute without opening the response panel); Counter quote; Request improvement; Notify dealers they are covering; Notify dealers they are winning; Spot. One or more of the following pool details may be displayed: Ticker; Description; Coupon; Original Face; Current Face; Settle Date; Benchmark; Hedge amount; Status; Outright/Swap; Spot timing; Dealer Responses (Dealer Acronym, Level, Benchmark price).

In some embodiments, execution may be a two-click event. The Dealer is preferably given the last look on all executions.

In some embodiments, alerting (e.g., audible alerts) may also be implemented. For example, for lists, there may be customer preferences that if set can generate an alert when the list due-in time is complete. In some embodiments, for spotting, if a customer decides to “spot later” they can set a reminder/alert that will generate a pop-up reminding them to spot (this can be a preference with different time options).

In some embodiments, the dealer software display for customer responses may include, for example, a dropdown in the client single item negotiation view with the following exemplary message options that the client can send to the dealer: (i) “Not Winning”—Validation: Dealer(s) selected must not be winning and must not be tied for best, otherwise block sending message; (ii) “Tied”—Validation: Dealer(s) selected must be tied for best, otherwise block sending message; (iii) “Tied, improve quote to win”—Validation: There can only be one dealer selected and that dealer must be tied for best, therwise block sending message; (iv) “Tied, jump ball”—Validation: There must be multiple dealers selected that are tied for best, otherwise block sending message; (v) Counter—Validation: Must include level, only one dealer can be selected, otherwise block sending counter; (vi) Retract previous message; (vii) “Winning”—Validation: Dealer selected must be best level.

Further customer response rules may be applied, for example as follows. In some embodiments, if there is a customer counter that is still out at any dealer, then the client cannot hit any levels (including that dealer's current level) or send any other counters or requests for improvements to any dealers. In some embodiments, the system may display an appropriate error message to the buy side user if sending request for improvement is disabled. In one embodiment if a dealer does not respond within a defined period of time the level can be repeated so that the customer can still engage with that dealer and other dealers.

### Spotting

Spotting logic is preferably provided with spotting options (immediately vs. later and auto vs. not-auto) configured at list-level. In some embodiments, spotting optionality applies just to lists/groups that have quote type set to pay up. In some embodiments, if a list item is agreed on pay up and spot immediately is selected, the platform sends a spot request for that item to dealer on behalf of client with composite level, and dealer sends level to client. In some embodiments, if auto-accept is activated, if dealer's level is within a predetermined tolerance/threshhold (e.g., within 5% of composite), trade is completed and spot is completed, otherwise client has the option to accept, reject, or counter. If auto-accept is not activated, client has the option to accept, reject, or counter. If client rejects level, the spot fails and spot negotiation must be initiated later. If client counters, dealer has option to accept (trade done, spot done) reject (spot fails), or counter back (and back to “dealer sends level to client” step). If a list item is agreed on pay up and spot later is selected, the process is the same as above, except the client initiates the initial spot request. Regarding TBA Hedges, for a list/group that is marked as swap, the spotting routine outlined above (a per-line-item routine) serves to set the levels of the TBAs that are being traded for each constituent pool in that list. TBA hedge requests go to the same desk that traded pool.

Aggregate spotting and swapping: In some embodiments, spotting applies to outright trades executed on pay up; and hedging applies to swapped trades executed on pay up.

Net spotting :In some embodiments, any originator pool trade that was traded on pay up and has not yet been spotted is eligible to be net spotted together with other such pool trades of the same TBA benchmark that were traded with the same dealer. This action may be completed in a separate net spotting matrix blotter. Net spotting is supported across lists.

Net hedging: Similarly, any originator pool that was traded on pay up and swap and was not already spotted/swapped is eligible to be net swapped together with other such pool trades of the same TBA benchmark that were traded with the same dealer. This action may be completed in a separate net swapping matrix blotter. Again, TBA hedge requests go to the same desk that traded pool. Net hedging is supported across lists.

If a list contained 1 individual item and an AON group of 2 pools all with the same FN 3.5 SEP benchmark, all with the same winning dealer, the client can request a single hedge across all 3 pools. For example, a client executed 3 trades on Swap vs. FN 3.5 Sep with DLRX (Trade 1=1.5MM @ 1-001; Trade 2=2.0MM @ 2-00; Trade 3=3.75MM @ 1-00+). Total hedge quantity=7.25MM. In some embodiments, the client may be able to adjust the hedge quantity up or down to avoid tail pieces (e.g., adjust hedge quantity to 7MM). The client sends a spot request for the adjusted hedge quantity from DLRX. Ticket should default to the TW Composite for FN 3.5 Sep; Dealer can Accept or respond with a new price; Dealer responds with a price for 7MM FN 3.5 Sep @ 100-00. The client accepts the spot price. The client BUYS 7MM FN 3.5 @ 100-00; and sells pools to DLR X (Trade 1=1.5MM @ 101-001; Trade 2=2.0MM @ 102-00; Trade 3=3.75MM @ 101-00+).

### Trading to Defined Cover

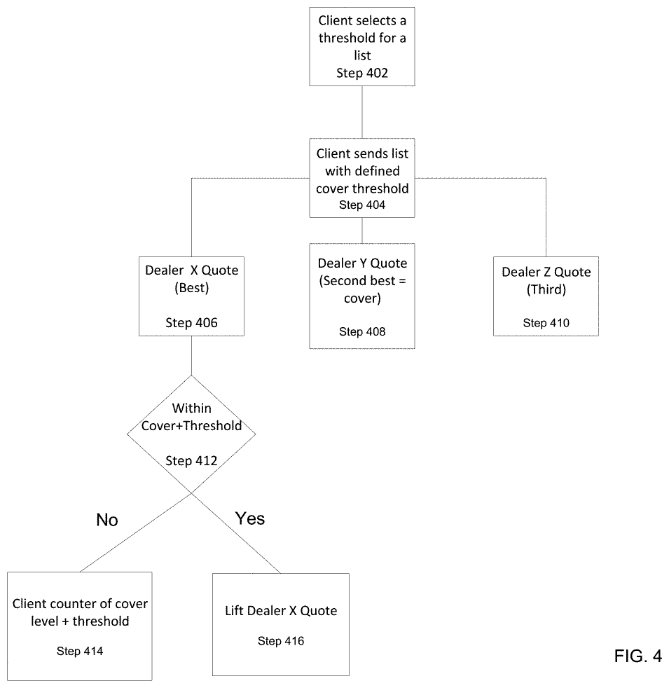

In one embodiment clients can trade at a defined cover whereby the client would be protected against aggressively quoting dealers by guaranteeing their levels will be countered at a cover price (i.e., the second best quote) plus the threshold set by the client. As can be seen in FIG. 4 in a defined cover trade the client selects a threshold for a list (Step 402). This threshold can for example be set to 1, ½, ¼, ⅛, or 0. The client then sends a list for quote with a threshold (Step 404). As can be appreciated in different embodiments a single threshold can be set for the entire list or can be varied across the list. Multiple dealers can then provide quotes. In the example shown in FIG. 4, dealer X provided the best quote (Step 406), dealer Y provided the second best quote (Step 408) and dealer z provided the third best quote (Step 410). The second best quote is established as the cover. It is then determined whether or not the best quote is within the cover+threshold (Step 412). If the best quote is not within such cover+threshold the cover+threshold is used as a counter offer (Step 414). If the best quote is within such cover+threshold the best quote is hit (i.e., not used as a counter) (Step 416). For example if the client chose to enable a defined control protocol with threshold of ½, then if the best dealer's level is 100 and the cover's level is 99, then a counter of 99½ would be sent to the best dealer.

### Post Trade

Embodiments of the present invention can provide information after the auction to all recipients or to participating dealers (those that provided a bid). This information may be produced, for example, by systematically providing covers in the dealer software (e.g., a user preference or list level option that will determine who receives cover information in dealer software). Additionally, a download option may be provided on the negotiation page.

Trade detail may include, for example, one or more of the following: Direction; Pool Quantity (original and current face); Pool factor; Pool description (Description, Ticker, Coupon); Pool CUSIP (if available); Trade type; Quote type; Spot timing; User info (Trader name, User ID); Trade date; Trade time; Settle date; Counterparty; Sales coverage; Traded level; Pool price (dec); Pool price (32nd); Principal, Accrued, Net; Cover quote; TBA Info (TBA Description, TBA Quantity, TBA Settle, TBA Price (dec), TBA Price (32nd), TBA CUSIP, TBA direction, TBA principal), TBA total); Competing Quotes. The trade detail page is preferably printable.

Once a list is completed, the client negotiation screen may have a download option that can include, for example, the following information: Line#; Ticker; Coupon; Description; Traded level; Cover level.

The recap screen can display all quotes at the time of execution.

In some embodiments, a dealer post trade feed may be provided. The pre-established descriptions (described above) can be passed in the post trade messages for all trades. For Stip'd Pre-CUSIP TBAs, the CUSIP field is not populated; instead, the Stip'd TBA “CUSIP” (a string determined by ticker/coupon/settle) can be passed in its own field in post trade messages.

In some embodiments, a buy side post trade feed may also be provided. This may include, for example, whether or not the quote of the trade was axed (as described above) and/or the other live quotes for that item and associated dealers at the time the trade was executed. In some embodiments, a post trade flat file with same data may also be supported.

In some embodiments, if authorized by the client, the system may provide cover information on each bond within the dealer software (e.g., a notification or ticket). Preferably, covers will be displayed in the dealer software after the list is complete.

In some embodiments, an export feature may be provided from the negotiation page that includes some or all of the following information: Ticker; Description; CPN; Traded price; Cover price.

In some embodiments, for trades that are executed on swap versus TBA, post trade feed enhancements may be implemented to allow front-end trade booking systems to link a pool or multiple pools with the benchmark TBA. RPTHEDGEID is a FIX tag that will contain like values for trade linking purposes. A FIX tag is a unique identifier as part of FIX (Financial Information eXchange) language that allows the present trading system to communicate specific information with external software systems. The post-trade feed and trading API leverages FIX protocol. RPTHEDGEID has been added to the FIX language library to link specified pools with their respective benchmarks when RPTHEDGEID contains a like integer in the message.

### Limits

Trading limits, expressed in original and current face for specified pools, are also supported in various embodiments of the present invention.

### User Preferences

Embodiments of the invention preferably support one or more of the following user preferences: Default timers (Due in/At, Length of time or time of day, Trading session, etc.); Individual/AON; Swap/Outright; RFQ on Pay-up or $ Price; Spot Timing; Hedge rounding preference (e.g., Nearest 1MM, Nearest 100K, etc.); Pool settlement (e.g., T+3, Reg (Match TBA), etc.); List Alerting (e.g, when due in time is complete); Spot Alerting (e.g, time preference); cover policy preference (e.g., in 32nds—1, ½, ¼, ⅛, 0) and allocation preferences (e.g., copy pool allocation to TBA, TBA default allocation account/group, pool default allocation account/group).

### Dealer Software

Embodiments of the invention preferably provide traders and primary sales persons the ability to quote lists. Moreover, for each primary sales person, there may be a group of covering traders that can quote on behalf of the primary sales person. In some embodiments, a unique book may be created for each primary sales person that can be covered by the direct reports of that primary sales person. In some embodiments, the following authorizations may be offered: View Only, Quote Only, View and Trade.

In some embodiments, if separate dealer software is used for specified pools, then single sign on may optionally be used for dealers that participate on the MBS platform. Support may be provided for a single login to the TBA and dealer software instances.

The DS list ticket may include one or more of the following features: Present all groups in a unified ticket; Present all line items in client's sent order; Allow quoting AON groups separately with single level; Items of Individual groups are quoted individually; Configurable Columns (Super-set of columns displayed; User can arrange columns); Ability to show static pool descriptive data; Ability to indicate an axe; Ability to paste quotes into the ticket using existing quote formatting; Ability to display eMBS data via a “side panel” opened by clicking a row.

A list blotter may be provided, for example, comprising tabs in both dealer software and client software. In preferred embodiments, the user can sort each column. Traders can view all trades or “my trades.” Functionality may be provided to arrange columns and/or sort columns. In some embodiments, opening tickets from the blotter may be governed by a user preference that determines if a user will have a single window or multiple windows. Additional preferences may be used to determine if a list ticket should pop up on certain events. In some embodiments, list ticket columns may be as shown in Table 15.

TABLE 15

| Header | Filter type | Comment |
|---|---|---|
| TIME | N/A | Time the request was submitted |
| EVENT | Drop list | Latest line item event from the list (HIT, Tie |
| | | break, improve) |
| DUE AT | N/A | The time the bids are due in the users |
| | | time zone |
| REMAINING | N/A | Countdown from current time until |
| | | due in |
| LIST STATE | Drop list | Bids wanted, Trading, Completed, |
| | | Ended, |
| COMPANY | Drop list | Alphabetical list of company names |
| CUSTOMER | Drop list | Alphabetical list of customer names |
| LIST NAME | Text | Client defined list name |
| POOLS | Text | Total number of pools on the list |
| ORIGINAL | | |
| CURRENT | | |
| QUOTES | Y/N Drop | Y = user quoted at least one pool |
| TRADES | Y/N Drop | Y = user won at least one trade |

In some embodiments, various DS user preferences may optionally be provided, such as, but not limited to: Blotter window management (One window, Multiple windows); Event pop-ups (e.g., Pop up on HIT—Yes/No; Pop up on Improve—Yes/No; Pop up on Tie break—Yes/No; Pop up on Spot request—Yes/No).

In some embodiments, multiple window behavior may be as follows. Pop up tickets, spot tickets and tickets launched from the list blotter may have their own behaviors. Pop up tickets appear in the most recent position. Tickets launched from the list blotter appear in their most recent position. In some embodiments, the user may be given the ability specify, for example: Pop up tickets appear in location A; Blotter launched tickets appear in location B; Spot requests appear in location C.

Audible notifications may also be supported. Preferably the user is given the ability to define a sound for various events, such as: New list; Hit; Improve; Break tie; Spot request; Trade spotted/complete.

### Non-Trading Views

In some embodiments, authorized sales users may be able see any quote provided by their firm in real time. The sales screen may include any timers associated with the trade (e.g., Due in/Trading time). In the current version of MBS dealer software, trade routing is dictated by security maturity ranges that are contained in defined/customizable trading books. In MBSP dealer software, trade routing is dictated first by salesperson then by security maturity ranges to prevent customer and/or trade information leakage across a dealer's salesforce. In some embodiments of the present system, a salesperson's login ID is tradelisted (linked) to their customer's login IDs. Each salesperson will have their own trading book in dealer software so that they will only receive trade inquiries from their assigned (tradelisted) counterparties. Traders will “cover” each salesperson's book to ensure that they receive all trade inquiries. On a secondary level, traders will “cover” or “not cover” certain security maturity ranges contained within a salesperson's book to customize the trade inquiries received.

In some embodiments, authorized administrative/support persons may be able to see a view only version of the client trading screen, where all timers and all quotes may be visible.

### Additional Specifications

In some embodiments, the platform may allow a dealer to indicate that they are axed when responding to a bid list. If an axe indication is provided as part of a quote, the following statistics may be tracked to measure the usefulness: % if axed and won; % if axed and cover.

In some embodiments, once a list is done on pay up or dollar price, a button is provided that can produce an Excel file with each line item that includes basic descriptive details, cover level, and traded level. The client can then provide that file (e.g., via email) to any desired recipient.

### System Architecture

In an exemplary embodiment, the system architecture of the computerized system and method includes hardware, system software and application software. The system hardware may include one or more mainframe computers or other specialized computers and hardware each having at least one processor and memory. The system hardware may additionally include other components such as storage and network components (i.e., servers, routers, switches, data buses, databases, etc.), networked to the mainframe computer and any external connections as would be understood by a person of ordinary skill in the art having the benefits of the present disclosure. In an exemplary embodiment, a computerized electronic trading system and method includes a plurality of user computers through which the customers and dealers can process their trades. The system preferably includes one or more computer systems that can include one or more software modules, databases and related database management systems. Customer computers can also typically connect to or include an OMS to assist in the execution and trading of securities. Various input and output devices are preferably provided with the customer computers and dealer computers including, by way of non-limiting example, a display (e.g., liquid crystal display (LCD)), and an input device (e.g., a keyboard, mouse, touch pad, or light pen). Preferably, an Application Programming Interface (“API”) is used to connect the dealer and customer to the electronic trading system and perform certain tasks automatically. For example, an API may be utilized by customer to connect their system with the electronic trading system for the purpose of sending orders which can eventually be converted for the dealer. Dealers may connect via an API for the purpose of providing the trading system with price information, for example by having an automated dealer trading system communicatively coupled to the trading system. The customer and dealer computers would also preferably include a storage device such as, for example, a magnetic disk drive and magnetic disk or other equivalent device. Certain of the specific hardware combination/configuration may vary as a matter of design choice within the functional parameters disclosed herein. Users (customers, dealers, buyers, sellers and traders) of the trading system typically interact with the Graphical User Interfaces (“GUI's”) displayed by the software modules by “clicking” on numbers or graphics (e.g., buttons) that are displayed on the GUI's. Persons of skill in the art will understand that the present invention is not limited to clicking with a computer mouse or any of the above listed hardware or software modules, but includes use of any other device for indicating an action with graphics-based software and other hardware and software arrangements.

It should be noted that the embodiments described may use multiple software modules for performing the various functions of the system, while other embodiments could be implemented using any number of modules, with any single module incorporating the functions of several, or all, of the modules. The precise design of the software and the programming language used may be designed differently within the scope of the present invention. The software modules can be created using art recognized programming languages including, but not limited to, Python, C++, ASP, Java, C#, ASP.NET, or PHP or any combination of known or later developed programming languages that allow the functionality described.

The software functions of the computerized electronic trading system and method described herein may be programmed via application software, system software or any combination thereof, and may be executable on one or more hardware components within the system, external to the system or some combination thereof. In some embodiments, system and/or application level software may reside on system hardware, various external customer computer systems, or some combination thereof.

Similarly, the implementation of various software functions described herein may at times overlap. In various embodiments, some software components may be stored in hardware residing within the system, external to the system or some combination thereof. For example, in some embodiments a software implementation may consist of a stand-alone application installed on a mainframe computer. In other embodiments, certain aspects may reside on customer hardware programmed to communicate with the trading system and method. Accordingly, the present invention will be understood to include those variations as would be understood by a person of ordinary skill in the art having the benefits of the present disclosure.

It will also be understood that the various embodiments of the present invention can be realized through a web-based centralized server architecture, thin client, fat client, or peer-to-peer type arrangement, which could be substituted for other system architecture and are within the scope of the present invention. Additionally, the programming described herein can be stored in a machine readable form on a computer readable medium, such as a CD-ROM, DVD or other storage medium, and distributed to users for installation on user computers. Alternatively, such programming can be downloaded via network. In either embodiment, communication with the system may be effected across known networks, such as the Internet.

It should be noted that references herein to phrases such as “one embodiment” or “an embodiment” mean that a particular feature, structure or characteristic described in connection with the embodiment is included in at least one embodiment of the invention. The phrases such as “in one embodiment” or “in certain embodiments” in various places in the specification are not necessarily, but can be, referring to the same embodiment. Use of the term “preferred” or “preferably” is intended to indicate a configuration, set-up, feature, process, or alternative that may be perceived by the inventor(s) hereof, as of the filing date, to constitute the best, or at least a better, alternative to other such configurations, set-ups, features, processes, or alternatives. In no way shall the use of the term “preferred” or “preferably” be deemed to limit the scope of the claims hereof to any particular configuration, set-up, feature, process, or alternative.

It will be further appreciated by those skilled in the art that the appended figures are purely illustrative, and that the system may be implemented in any number of ways, by the actual designers, as long as the functionality as described above, stays intact.

While there have been shown and described fundamental novel features of the invention as applied to the preferred and illustrative embodiments thereof, it will be understood that omissions and substitutions and changes in the form and details of the disclosed invention may be made by those skilled in the art without departing from the spirit of the invention and the broad inventive concept thereof. Moreover, numerous modifications and changes may readily occur to those skilled in the art. For example, various features and structures of the different embodiments discussed herein may be combined and interchanged. Hence, it is not desired to limit the invention to the exact construction and operation shown and described and, accordingly, all suitable modification equivalents may be resorted to falling within the scope of the invention as claimed.

What is claimed is:

1. (canceled)

2. (canceled)

3. (canceled)

4. A computer implemented method of executing transactions of pools of asset-backed securities utilizing a trading platform the method comprising:
receiving through the trading platform a listing of pools of asset-backed securities from a first user;
displaying through the trading platform the listing of pools of asset-backed securities simultaneously for one or more second users and one or more dealers;
receiving through the trading platform from one or more of the second users multiple price quotes related to one or more of the pools of asset-backed securities;
sending through the trading platform the multiple price quotes to a specified dealer from the one or more second users;
aggregating through the trading platform the one or more price quotes;
sending through the trading platform one or more of the multiple price quotes to the first user from the specified dealer; wherein if the first user approves a price quote of a second user received from the specified dealer, the specified dealer executes a first transaction based on said price quote through the trading platform with the first user and a second transaction based on said price quote through the trading platform with the second user.

5. The method of claim 4 wherein the first user is a seller.

6. The method of claim 4 wherein the second user is a buyer.

7. The method of claim 4 wherein the first user is a buyer.

8. The method of claim 4 wherein the second user is a seller.

9. The method of claim 4 wherein at least one of the multiple price quotes sent to the first user from the specified dealer are generated by the specified dealer.
